(19) United States
(12) Patent Application Publication
(10) Pub. No.: US 2024/0198837 A1
(43) Pub. Date: Jun. 20, 2024

(54) CHARGING CONTROL DEVICE AND CHARGING CONTROL METHOD

(71) Applicant: TOYOTA JIDOSHA KABUSHIKI KAISHA, Toyota-shi, Aichi-ken (JP)

(72) Inventor: Tohru NAKAMURA, Toyota-shi (JP)

(21) Appl. No.: 18/474,521

(22) Filed: Sep. 26, 2023

(30) Foreign Application Priority Data
Dec. 19, 2022 (JP) 2022-202123

(51) Int. Cl. B60L 53/62; B60L 53/66; B60L 53/68; B60L 58/12

(52) U.S. Cl. CPC B60L 53/62; B60L 53/66; B60L 53/68; B60L 58/12

(57) ABSTRACT

The server (charging control device) includes a communication unit (charging information acquisition unit) that acquires information on charging of a battery (secondary battery), and a processor (charging control unit) that controls charging of the battery. When VPP charge/discharge mode (first charging mode) in which charging is performed based on a predetermined operation plan is set, the processor executes a VPP charging process (first charging process) in which charging is performed in a range in which SOC of the battery is less than a predetermined charging threshold. When the normal charging/discharging mode (second charging mode) in which the charging plan is determined by the user of electrified vehicle 10 is set, the processor executes a normal charging/discharging process (second charging process) in which SOC performs charging up to a value equal to or larger than a predetermined charging threshold value.

### CROSS-REFERENCE TO RELATED APPLICATION

This application claims priority to Japanese Patent Application No. 2022-202123 filed on Dec. 19, 2022 incorporated herein by reference in its entirety.

### BACKGROUND

### 1. Technical Field

The present disclosure relates to a charging control device and a charging control method.

### 2. Description of Related Art

Japanese Unexamined Patent Application Publication No. 2020-156149 (JP 2020-156149 A) discloses a system for controlling a charging and discharging operation of a power device to be operated in a virtual power plant (VPP) system in accordance with a predetermined operation plan.

### SUMMARY

Here, charging power of a power device such as an electrified vehicle decreases when it approaches a full charging capacity. Therefore, in the system described in JP 2020-156149 A, charging in accordance with the operation plan may be difficult due to a decrease in the charging power of the power device. Therefore, it is desired to easily charge the power device (electrified vehicle) in accordance with the operation plan.

The present disclosure has been made to solve the above issue. An object of the present disclosure is to provide a charging control device and a charging control method capable of easily charging the electrified vehicle in accordance with the operation plan.

A charging control device according to a first aspect of the present disclosure is
a charging control device for controlling charging of a secondary battery mounted on an electrified vehicle, and includes:
a charging information acquisition unit for acquiring information on the charging of the secondary battery; and
a charging control unit for controlling the charging of the secondary battery.

The charging control unit
executes, when a first charging mode in which the charging is performed based on a predetermined operation plan is set, a first charging process for executing the charging in a range in which a state of charge of the secondary battery is less than a predetermined charging threshold value, and
executes, when a second charging mode in which a plan for the charging is determined by a user of the electrified vehicle is set, a second charging process for executing the charging until the state of charge becomes a value equal to or greater than the predetermined charging threshold value.

In the charging control device according to the first aspect of the present disclosure, as described above, when the first charging mode in which the charging is performed based on the predetermined operation plan is set, the first charging process for executing the charging in the range in which the state of charge is less than the predetermined charging threshold value is executed. Further, in the charging control device, when the second charging mode in which the plan for the charging is determined by the user of the electrified vehicle is set, the second charging process for executing the charging until the state of charge becomes the value equal to or greater than the predetermined charging threshold value is executed. Thus, it is possible to suppress the charging in accordance with the operation plan from being performed in the range in which the state of charge of the electrified vehicle is equal to or greater than the predetermined charging threshold value. Therefore, it is possible to suppress the charging in accordance with the operation plan from being performed while the charging power of the electrified vehicle decreases. Consequently, the electrified vehicle can be easily charged in accordance with the operation plan. Further, since the second charging process can be executed, the electrified vehicle can be also charged in the range in which the state of charge is equal to or greater than the predetermined charging threshold value.

In the charging control device according to the first aspect, preferably, the electrified vehicle is controlled such that charging power of the secondary battery is reduced when the state of charge is equal to or greater than a specified value as compared with a case in which the state of charge is less than the specified value.

The predetermined charging threshold value is a value less than the specified value.

With this configuration, it is possible to further suppress the state of charge from becoming equal to or greater than the specified value in the first charging process.

In the charging control device according to the first aspect, preferably, the charging information acquisition unit acquires information on a target value of the user related to the state of charge.

When the target value is greater than the predetermined charging threshold value, the charging control unit executes the charging until the state of charge reaches the target value by the second charging process after the first charging process.

With this configuration, even when the target value is greater than the predetermined charging threshold value, the second charging process can cause the state of charge to easily reach the target value.

In this case, preferably,
the charging control unit reduces a time period in which the first charging process is executed based on the operation plan as a difference between the target value and the predetermined charging threshold value is large.

With this configuration, it is possible to increase the time period in which the second charging process is executed as the difference increases. Consequently, even when the target value is greater than the predetermined charging threshold value, the second charging process can cause the state of charge to more easily reach the target value.

A charging control method according to a second aspect of the present disclosure is
a charging control method for controlling charging of a secondary battery mounted on an electrified vehicle, and includes:
a step pf acquiring information on the charging of the secondary battery;
a step of executing, when a first charging mode in which the charging is performed based on a predetermined operation plan is set, a first charging process for executing the charging in a range in which a state of charge of the secondary battery is less than a predetermined charging threshold value; and
a step of executing, when a second charging mode in which a plan for the charging is determined by a user of the electrified vehicle is set, a second charging process for executing the charging until the state of charge becomes a value equal to or greater than the predetermined charging threshold value.

In the charging control method according to the second aspect of the present disclosure, as described above, when the first charging mode in which the charging is performed based on the predetermined operation plan is set, the first charging process for executing the charging in the range in which the state of charge is less than the predetermined charging threshold value is executed. Further, in the charging control method, when the second charging mode in which the plan for the charging is determined by the user of the electrified vehicle is set, the second charging process for executing the charging until the state of charge becomes the value equal to or greater than the predetermined charging threshold value is executed. Accordingly, it is possible to provide the charging control method capable of easily charging the electrified vehicle in accordance with the operation plan.

A discharging control device according to a third aspect of the present disclosure is a discharging control device for controlling discharging of a secondary battery mounted on an electrified vehicle based on a set discharging mode. The discharging control device includes a discharging information acquisition unit for acquiring information on a predetermined discharging threshold value for a state of charge of the secondary battery, and a discharging control unit for controlling the discharging of the secondary battery. The discharging control unit executes a discharging process for executing the discharging in a range in which the state of charge is greater than a predetermined discharging threshold value when a discharging mode in which the discharging is performed based on a predetermined operation plan is set.

In the discharging control device according to the third aspect of the present disclosure, as described above, when the discharging mode in which the discharging is performed based on the predetermined operation plan is set, the discharging process for executing the discharging in the range in which the state of charge is greater than the predetermined discharging threshold value is executed. Accordingly, it is possible to suppress the discharging in accordance with the operation plan from being performed in the range in which the state of charge of the electrified vehicle is equal to or less than the predetermined discharging threshold value. Therefore, it is possible to suppress the discharging of the electrified vehicle from being stopped during the discharging in accordance with the operation plan. Consequently, the electrified vehicle can be easily discharged in accordance with the operation plan.

According to the present disclosure, the electrified vehicle can be easily charged in accordance with the operation plan.

### BRIEF DESCRIPTION OF THE DRAWINGS

Features, advantages, and technical and industrial significance of exemplary embodiments of the present disclosure will be described below with reference to the accompanying drawings, in which like signs denote like elements, and wherein:

FIG. 1 is a diagram illustrating a configuration of a charge/discharge control system according to an embodiment;

FIG. 2 is a diagram illustrating a relation between the charge power of the battery and SOC;

FIG. 3 is a diagram illustrating a relation between discharging power of a battery and SOC;

FIG. 4 is a first diagram illustrating a sequence of a charge/discharge control system according to an embodiment;

FIG. 5 is a diagram illustrating a relation between a difference between a target SOC of a battery and charge thresholds and a length of a VPP control interval;

FIG. 6 is a second diagram illustrating a sequencing of a charge/discharge control system according to an embodiment; and

FIG. 7 is a diagram illustrating a configuration of a charge/discharge control system according to a modification of the embodiment.

### DETAILED DESCRIPTION OF EMBODIMENTS

Hereinafter, embodiments of the present disclosure will be described in detail with reference to the drawings. In the drawings, the same or corresponding parts are denoted by the same reference numerals, and the description thereof will not be repeated.

### Configuration of Charge/Discharge Control System

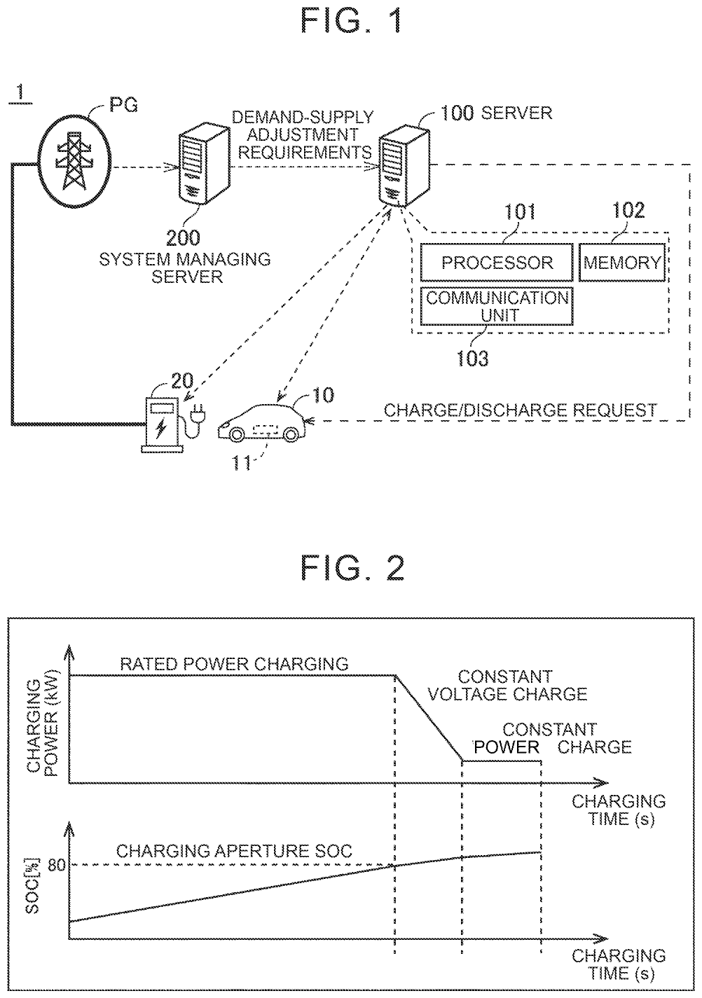

FIG. 1 is a diagram illustrating a configuration of a charge/discharge control system 1 according to the present embodiment. The charge/discharge control system 1 includes a server 100, a system managing server 200, a power grid PG, an electrified vehicle 10, and an Electric Vehicle Supply Equipment (EVSE) 20. Note that the server 100 is an example of a “charging control device” of the present disclosure.

The power grid PG is a power grid constructed by a power plant and a transmission and distribution facility (not shown). The system managing servers 200 manage power supply and demand in the power grid PG (power grid). The system managing server 200 transmits a request (a request for adjusting power supply and demand) for adjusting the power demand of the power grid PG to the server 100 (a communication unit 103 to be described later) based on the generated power and the power consumed by the respective power adjustment resources managed by the system managing server 200.

The coordination request includes a request for charging the battery 11 in accordance with a predetermined operation plan in Virtual Power Plant (VPP) control. Specifically, the adjustment request includes a request for a charging and discharging execution time (time zone) according to VPP control, a request for a charging amount (charging power) and a discharging amount (discharging power) according to VPP control, and the like. Note that the adjustment request is an example of “information on charging of a secondary battery” of the present disclosure.

Electrified vehicle 10 charges and discharges electric power to and from the power grid PG via EVSE 20. Electrified vehicle 10 is equipped with a battery 11 for supplying electric power to a power device (not shown) provided in electrified vehicle 10. The battery 11 is an example of a “secondary battery” of the present disclosure.

As shown in FIG. 2, in electrified vehicle 10, the battery 11 is charged with the rated power at a State Of Charge (SOC) of less than the charging aperture SOC (for example, 80%). Further, the charging power of electrified vehicle 10 is lower than the rated power when SOC of the battery 11 is equal to or larger than the charging aperture SOC. Specifically, when SOC is less than the charging aperture SOC, the charge power gradually decreases due to the constant-voltage charge being performed as SOC of the battery 11 is increased. Thereafter, the constant power charging is performed with a power lower than the rated power. Note that the charging aperture SOC is an exemplary “specified value” of the present disclosure.

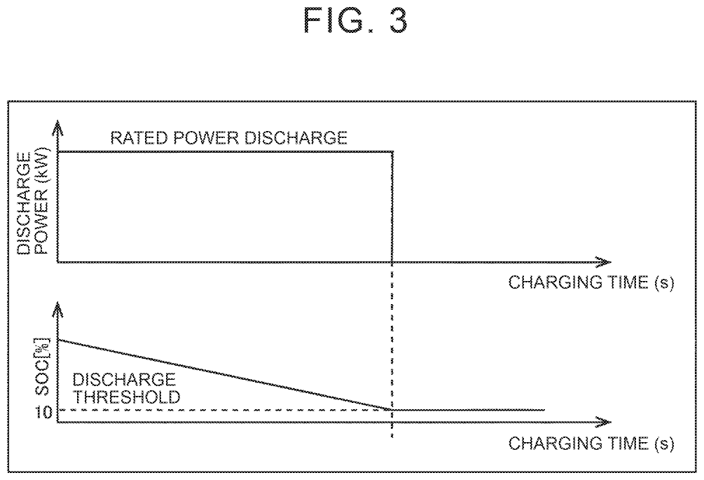

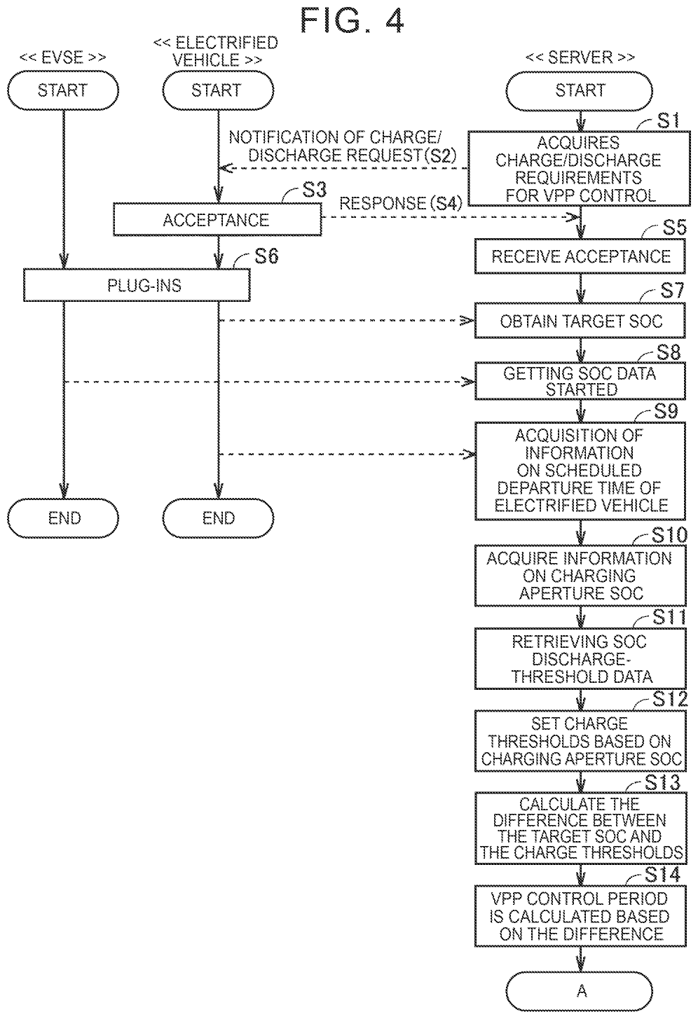

As illustrated in FIG. 3, in electrified vehicle 10, the discharge is performed by the rated power in a range in which SOC of the battery 11 is larger than a predetermined discharge threshold (for example, 10%). When SOC of the battery 11 is equal to or less than the discharge threshold, the discharge of the battery 11 is stopped.

Referring again to FIG. 1, the server 100 is a server managed by an aggregator. An aggregator is an electric utility that provides an energy management service by bundling a plurality of power adjustment resources such as a region and a predetermined facility.

The server 100 includes a processor 101, a memory 102, and a communication unit 103. Note that the processor 101 is an example of a “charging control unit” of the present disclosure. The communication unit 103 is an example of a “charging information acquisition unit” of the present disclosure.

The communication unit 103 can communicate with each of electrified vehicle 10, EVSE 20 and the system managing servers 200. For example, the communication unit 103 acquires information related to charging and discharging by electrified vehicle 10. Specifically, the communication unit 103 acquires information such as a charge/discharge amount, a charge/discharge time, and a time period in which charge/discharge is performed between the charged and discharged electrified vehicle 10 and EVSE 20.

The memory 102 stores a program to be executed by the processor 101 and information (for example, a map, a mathematical expression, and various parameters) used in the program.

The processor 101 controls charging and discharging of the battery 11 between electrified vehicle 10 and EVSE 20. The processor 101 sets VPP charging/discharging mode for performing the charging/discharging based on a predetermined operation plan. VPP charge/discharge mode is an exemplary “first charge mode” of the present disclosure.

VPP charge/discharge mode is a mode that is set in the server 100 (the processor 101) based on the above-described adjustment-request received by the communication unit 103.

When VPP charge/discharge mode is set, the processor 101 performs the above-described charge/discharge (VPP charge/discharge process) within a range in which SOC of the battery 11 is less than a predetermined charge threshold. Note that VPP charge/discharge process is an exemplary “first charging process” of the present disclosure.

Here, the charge thresholds are less than the charging aperture SOC. For example, if the charging aperture SOC is 80%, the processor 101 sets the charge thresholds to, for example, 70% to 80%. Thus, during VPP charge control, SOC of the battery 11 can be suppressed from becoming equal to or larger than the charging aperture SOC. Note that the charging threshold value may be set to a value other than the above value.

Further, in VPP charge/discharge process, the processor 101 performs the above-described charge/discharge in a range in which SOC is larger than a predetermined discharge threshold (for example, 10%). In addition, in VPP charge/discharge process, the processor 101 stops the charge/discharge in a range in which SOC is equal to or lower than the discharge threshold. That is, the discharge thresholds are lower limits of SOC in the charge-discharge process.

The processor 101 sets a normal charge/discharge mode in which the user decides the charge/discharge plan (execution time, execution time period, charge/discharge power amount, and the like) of the battery 11. Note that the normal charge/discharge mode is an example of the “second charge mode” of the present disclosure.

The normal charge/discharge mode is a charge/discharge mode set in the server 100 (the processor 101) based on a request from the user received by the communication unit 103.

When the normal charge/discharge mode is set, the processor 101 executes a normal charge/discharge process in which SOC performs charge up to a value equal to or larger than the charge threshold. In other words, in the normal charge/discharge mode, the processor 101 can increase SOC of the battery 11 from a value less than the charge threshold to a value greater than or equal to the charge threshold. When the normal charge/discharge mode is set, the battery 11 can be discharged even if SOC is equal to or larger than the charge threshold. Note that the normal charge/discharge process is an example of the “second charging process” of the present disclosure.

In the normal charge/discharge process, the processor 101 performs the charge/discharge in a range in which SOC is larger than the discharge threshold. In the normal charging/discharging process, the processor 101 stops the charging/discharging in a range in which SOC is equal to or lower than the discharge threshold.

### Sequence Control of Charge/Discharge Control System

Next, the sequence control of the charge/discharge control system 1 will be described with reference to FIGS. 4 to 6.

In S1, the servers 100 (the communication unit 103) receive the above-described adjustment request, and thereby acquire information (such as an execution time, an execution time period, and a charge/discharge power amount) related to the charge/discharge request of the battery 11 in VPP control.

In S2, the server 100 (the processor 101) notifies the user of electrified vehicle 10 of the charge/discharge request acquired in S1 through the communication unit 103. The charge/discharge request is transmitted to a communication device (not shown) of electrified vehicle 10 or a mobile terminal (not shown) of the user.

In S3, it is assumed that the charge/discharge request notified in S2 is accepted by the user of electrified vehicle 10.

In S4, the user of electrified vehicle 10 responds to the server 100 that the charge/discharge request is accepted in S3. In S5, the servers 100 (the communication unit 103) receive a reply in S4.

In S6, it is assumed that electrified vehicle 10 is plugged into EVSE 20 for VPP control according to the above-described coordination requirement.

In S7, the server 100 (the processor 101) acquires the target value (target SOC) of the user regarding SOC of the battery 11 through the communication unit 103. In the present embodiment, the target SOC is, for example, 95%.

In S8, the server 100 (the processor 101) starts acquiring SOC of the battery 11 from EVSE 20 through the communication unit 103. Thereafter, the servers 100 continuously acquire SOC of the battery 11. Note that SOC of the battery 11 may be acquired from electrified vehicle 10 through a telematics server or the like. In addition, the servers 100 (the processor 101) may estimate SOC of the battery 11 based on various types of data such as the travel history of electrified vehicle 10 and the history of charging and discharging. In the above estimation, a learned model generated by a machine learning technique such as deep learning may be used.

In S9, the servers 100 (the processor 101) acquire information about the scheduled departure time of electrified vehicle 10 from the user of electrified vehicle 10 through the communication unit 103. The scheduled departure time means a time at which electrified vehicle 10 starts traveling by leaving the charging and discharging through EVSE 20.

In S10, the servers 100 (the processor 101) acquire the charging aperture SOC of the battery 11. Specifically, the server 100 (the processor 101) estimates the charging aperture SOC by referring to the vehicle type of electrified vehicle 10. In addition, for example, a learned model generated by a machine-learning technique such as deep learning may be used to estimate the charging aperture SOC. Further, the charging aperture SOC may be estimated from a profile (power change data) of the battery 11 during normal charging, a pre-evaluation result regarding the charging of the battery 11, and the like. Note that the normal charging means charging corresponding to the normal charging and discharging process.

In S11, the servers 100 (the processor 101) acquire the discharging thresholds of the batteries 11. The discharging thresholds may also be acquired by a method similar to the method of acquiring the charging aperture SOC in S10.

In S12, the servers 100 (processor 101) set the charge thresholds based on the charging aperture SOC obtained in S10. Specifically, the processor 101 may set a value obtained by subtracting a predetermined value (for example, 0 to 10%) from the charging aperture SOC as the charge threshold.

In S13, the servers 100 (processor 101) calculate the difference between the target SOC obtained in S7 and the charge thresholds set in S12.

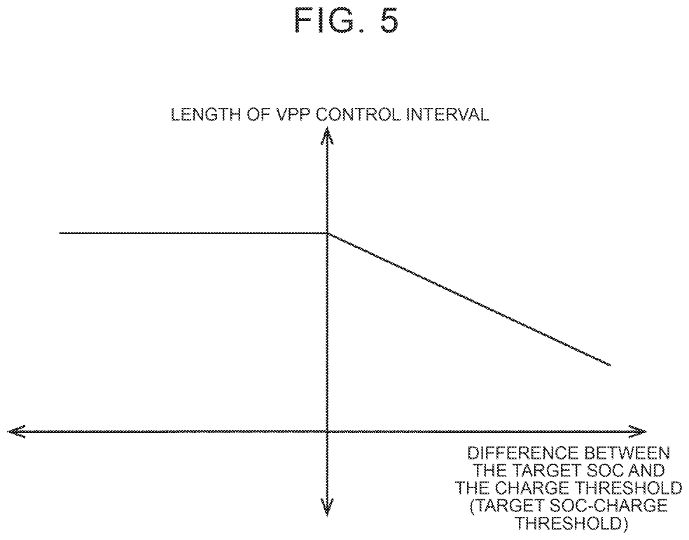

In S14, the servers 100 (the processor 101) calculate VPP control duration based on the difference calculated in S13. Specifically, as shown in FIG. 5, in a range in which the difference is positive (a range of 0 or more), the processor 101 increases VPP control period as the difference increases.

Further, the processor 101 may set the length of VPP control interval to be constant in a range in which the difference is negative (a range of less than 0).

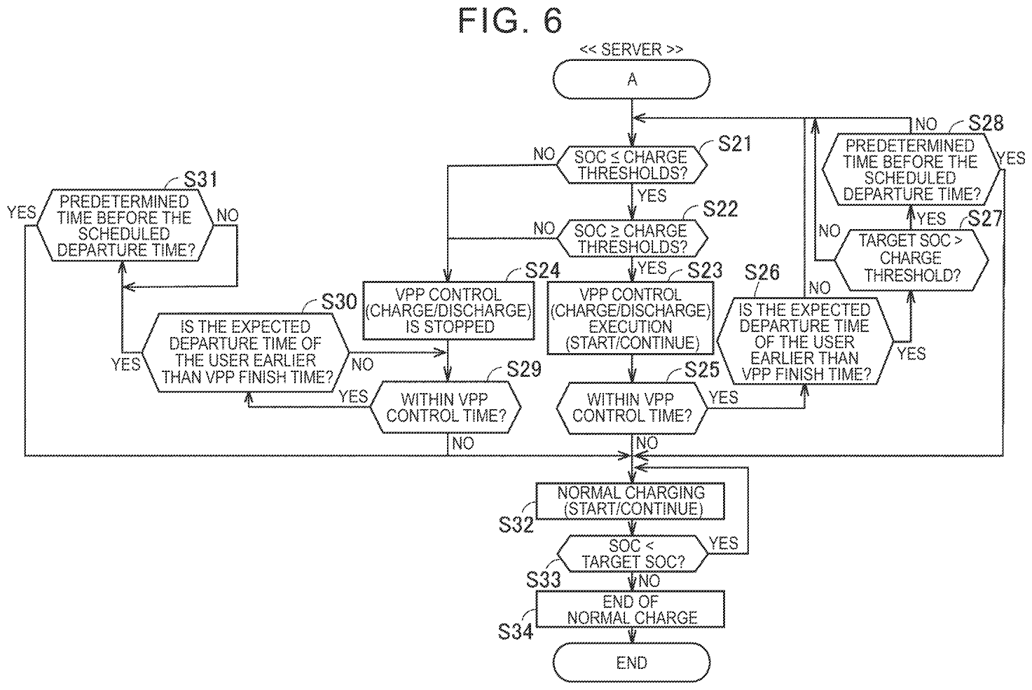

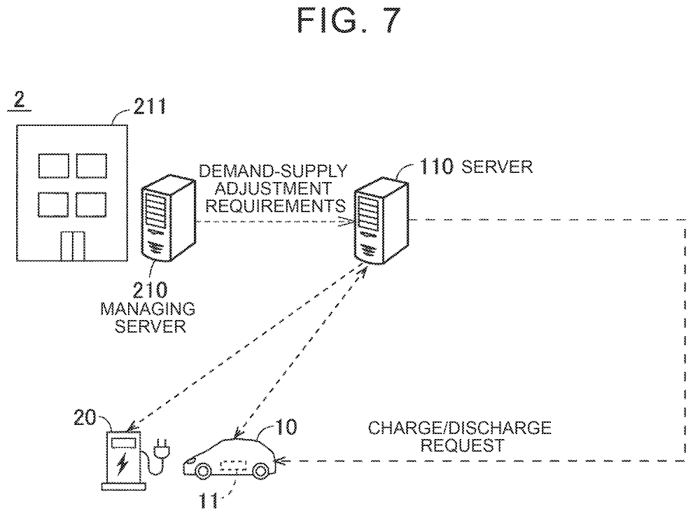

Next, referring to FIG. 6, a control flow of the servers 100 after S14 shown in FIG. 4 will be described.

In S21, the processor 101 determines whether SOC of the battery 11 is less than or equal to the charge thresholds set in S12 (see FIG. 4). When SOC of the battery 11 is equal to or less than the charge threshold (Yes in S21), the process proceeds to S22. If SOC of the battery 11 is greater than the charge thresholds (No in S21), the process proceeds to S24.

In S22, the processor 101 determines whether SOC of the battery 11 is greater than or equal to the discharging thresholds obtained in S11 (see FIG. 4). If SOC of the battery 11 is greater than or equal to the discharging threshold (Yes in S22), the process proceeds to S23. If SOC of the battery 11 is less than the charge thresholds (No in S22), the process proceeds to S24.

In S23, the processor 101 executes a charging/discharging process (VPP charge/discharge process) of the battery 11. Thus, VPP control is executed. When S23 is executed first, the charging/discharging process is started. In the second and subsequent S23, the charging/discharging process is continued.

In S24, the processor 101 stops executing the charging/discharging process (VPP charge/discharge process) of the battery 11. Thus, VPP control is stopped. If the charging/discharging process is in an unexecuted state prior to S24, the unexecuted state is continued.

In S25, the processor 101 determines whether or not the present time is within VPP control duration calculated in S14. If the present time is within VPP control interval (Yes in S25), the process proceeds to S26. If the present time is not within VPP control interval (No in S25), the process proceeds to S32.

In S26, the processor 101 determines whether the scheduled departure time of the user based on the information obtained in S9 is earlier than the termination time of VPP control period based on VPP control period calculated in S14. When the scheduled departure time is earlier than the ending time (Yes in S26), the process proceeds to S27. When the scheduled departure time is after the ending time (No in S26), the process returns to S21.

In S27, the processor 101 determines whether the target SOC is greater than the charge thresholds. If the target SOC is greater than the charge thresholds (Yes in S27), the process proceeds to S28. If the target SOC is less than or equal to the charge threshold (No in S27), the process returns to S21.

In S28, the processor 101 determines whether the present time is a predetermined time (e.g., 30 minutes) prior to the scheduled departure time. If the present time is a predetermined time prior to the scheduled departure time, the process proceeds to S32. If the present time is not a predetermined time prior to the scheduled departure time, the process returns to S21. The processor 101 may vary the predetermined period according to, for example, a target SOC. Specifically, the processor 101 may increase the predetermined period as the target SOC increases.

On the other hand, in S29, the processor 101 determines whether or not the present time is within VPP control time as in S25. If the present time is within VPP control interval (Yes in S29), the process proceeds to S30. If the present time is not within VPP control interval (No in S29), the process proceeds to S32.

In S30, the processor 101 determines whether the scheduled departure time of the user is earlier than the end time of VPP control interval, similar to S26. When the scheduled departure time is earlier than the ending time (Yes in S30), the process proceeds to S31. When the scheduled departure time is after the ending time (No in S30), the process returns to S29.

In S31, the processor 101 determines whether the present time is a predetermined time (e.g., 30 minutes) prior to the scheduled departure time, similar to S28. If the present time is a predetermined time prior to the scheduled departure time, the process proceeds to S32. If the present time is not a predetermined time prior to the scheduled departure time, S31 process is repeated.

In S32, the processor 101 executes normal charging based on the normal charging/discharging process of the battery 11. When S32 is executed first, the normal charge is started. In the second and subsequent S32, the normal charge is continued.

In S33, the processor 101 determines whether SOC of the battery 11 is smaller than the target SOC. When SOC of the battery 11 is smaller than the target SOC (Yes in S33), the process returns to S32. When SOC of the battery 11 is equal to or larger than the target SOC (No in S33), the process proceeds to S34. If No in the first S33, the process proceeds to S34 without performing the normal charge. Then, in S34, the processor 101 ends the normal charge process of the battery 11.

As described above, in the present embodiment, the processor 101 performs VPP charge/discharge process in which SOC of the battery 11 performs charging within the range below the charging threshold. In addition, the processor 101 executes a normal charging/discharging process in which SOC performs charging up to a value equal to or larger than the charging threshold. As a result, it is possible to suppress the charge power of the battery 11 from decreasing due to SOC of the battery 11 becoming equal to or higher than the charge thresholds during the charge of the battery 11 based on VPP charge/discharge process.

Further, in the present embodiment, when the target SOC is larger than the charge threshold, the processor 101 performs charge until SOC reaches the target SOC by the normal charge/discharge process after VPP charge/discharge process. Thus, SOC can be easily made larger than the charging threshold by normal charging and discharging in which the charging threshold is not set.

In the above embodiment, the charge of the battery 11 during VPP control is limited based on SOC of the battery 11. However, the present disclosure is not limited thereto. For example, the same control as in the above-described embodiment may be performed during the control period in the energy management. Specifically, as illustrated in FIG. 7, the server 110 of the charge control system 2 requests electrified vehicle 10 to charge and discharge the battery 11 on the basis of a demand-supply-demand-adjustment request from the managing server 210 that manages the power status of a predetermined facility (for example, the building 211). Note that the managing server 210 may manage the power state of a facility other than a building (for example, a factory, a house, and the like). In addition, the control of the modified example and the control of the above-described embodiment may be combined and executed. Note that the server 110 is an example of a “charging control device” of the present disclosure.

In the above embodiment, an example is shown in which a threshold is provided for both charging and discharging of the battery 11. However, the present disclosure is not limited thereto. A threshold value may be provided for only one of charging and discharging of the battery 11.

In the above embodiment, the charging aperture SOC is estimated in the servers. However, the present disclosure is not limited thereto. For example, the charging aperture SOC may be transmitted from a user of electrified vehicle 10 to the servers 100. Here, electrified vehicle 10 or servers 100 are based on the temperature.

The reference value of the charging aperture SOC corresponding to the reference temperature (air temperature) may be corrected. Also in the above-described embodiment, the servers 100 may correct the estimated charging aperture SOC based on the air temperature.

In the above embodiment, the charge thresholds that are less than the charging aperture SOC are set. However, the present disclosure is not limited thereto. The charging aperture SOC may be set as charge thresholds.

In the above-described embodiment, when the scheduled departure time of the user is earlier than VPP finish time, the control of shifting to the normal charge is performed a predetermined time prior to the scheduled departure time. However, the present disclosure is not limited thereto. This control may not be performed.

The embodiment disclosed herein should be considered as illustrative and not restrictive in all respects. The scope of the present disclosure is shown by the claims, rather than the above embodiment, and is intended to include all modifications within the meaning and the scope equivalent to those of the claims.

What is claimed is:

1. A charging control device for controlling charging of a secondary battery mounted on an electrified vehicle, the charging control device comprising:
a charging information acquisition unit for acquiring information on the charging of the secondary battery; and
a charging control unit for controlling the charging of the secondary battery, wherein the charging control unit
executes, when a first charging mode in which the charging is performed based on a predetermined operation plan is set, a first charging process for executing the charging in a range in which a state of charge of the secondary battery is less than a predetermined charging threshold value, and
executes, when a second charging mode in which a plan for the charging is determined by a user of the electrified vehicle is set, a second charging process for executing the charging until the state of charge becomes a value equal to or greater than the predetermined charging threshold value.

2. The charging control device according to claim 1, wherein:
the electrified vehicle is controlled such that charging power of the secondary battery is reduced when the state of charge is equal to or greater than a specified value as compared with a case in which the state of charge is less than the specified value; and
the predetermined charging threshold value is a value less than the specified value.

3. The charging control device according to claim 1, wherein:
the charging information acquisition unit acquires information on a target value of the user related to the state of charge; and
when the target value is greater than the predetermined charging threshold value, the charging control unit executes the charging until the state of charge reaches the target value by the second charging process after the first charging process.

4. The charging control device according to claim 3, wherein the charging control unit reduces a time period in which the first charging process is executed based on the operation plan as a difference between the target value and the predetermined charging threshold value is large.

5. A charging control method for controlling charging of a secondary battery mounted on an electrified vehicle, the charging control method comprising:
a step pf acquiring information on the charging of the secondary battery;
a step of executing, when a first charging mode in which the charging is performed based on a predetermined operation plan is set, a first charging process for executing the charging in a range in which a state of charge of the secondary battery is less than a predetermined charging threshold value; and
a step of executing, when a second charging mode in which a plan for the charging is determined by a user of the electrified vehicle is set, a second charging process for executing the charging until the state of charge becomes a value equal to or greater than the predetermined charging threshold value.
